(19) United States
(12) Patent Application Publication
(10) Pub. No.: US 2020/0158553 A1
(43) Pub. Date: May 21, 2020

(54) METHOD TO PREDICT REMAINING TIME AND EXPECTED CONSUMPTION BEFORE A FLUID SYSYTEM REACHES A LOW FLUID LEVEL

(71) Applicant: GM GLOBAL TECHNOLOGY OPERATIONS LLC, Detroit, MI (US)

(72) Inventors: Tyler J. Jamieson, North York (CA); DAVID C. COCHRANE, OSHAWA (CA); Tushita A. Sikder, Markham (CA)

(21) Appl. No.: 16/196,586

(22) Filed: Nov. 20, 2018

(51) Int. Cl. G01F 23/00; G01F 9/00; G01F 9/02

(52) U.S. Cl. CPC G01F 23/0007; G01F 9/023; G01F 9/008

(57) ABSTRACT

A method to predict time and/or distance remaining before a fluid system reaches a low fluid level includes determining a fluid level of the fluid system before execution of a fluid request command; determining an amount of time that fluid from the fluid system was spent in response to execution of the fluid request command; and determining external inputs that may affect a frequency of the fluid request command. A calculation of the risk of a low fluid level event occurring is made by inputting the current fluid level of the fluid system, the amount of time that fluid from the fluid system was being spent, and the external inputs that may affect the frequency of the fluid request command into a remaining useful fluid prediction model. A low fluid level alert is provided when the remaining useful fluid prediction model determines a low fluid event may occur.

### FIELD OF INVENTION

The present disclosure relates to vehicle on-board fluid level monitoring systems and more particularly to a method to predict remaining time and expected consumption before a fluid system reaches a low fluid level. After a low fluid level event is predicted to occur the method is operative to provide warnings to on-board and/or off-board alert systems.

### BACKGROUND

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

A wiper control system on a vehicle can be operated to spray washer fluid onto the windshield, typically using an electrical pump via jets mounted either beneath the windshield or beneath the wiper blade(s). The windshield wipers are automatically turned on, cleaning dirt and debris off the windshield. Some vehicles use the same method to clean the rear window or the headlights.

Current wiper control systems are unable to estimate how much washer fluid is required for an upcoming trip. Under certain conditions, not having enough washer fluid could result in a hazardous driving condition whereby the driver may lose some windshield visibility. Additionally, washer fluid pumps may become damaged if operated when the washer fluid becomes low or depleted which could result in the pump not being properly lubricated or cooled.

### SUMMARY

One or more exemplary embodiments address the above issues by providing a method to predict remaining time and expected consumption before a fluid system reaches a low fluid level.

A method to predict remaining time and expected consumption before a fluid system reaches a low fluid level in accordance with aspects of an exemplary embodiment includes determining a fluid level of the fluid system before execution of a fluid request command. Another aspect includes determining an amount of time that fluid from the fluid system was being spent in response to execution of the fluid request command. And another aspect includes determining a plurality of external inputs that may affect a frequency for initiating the fluid request command. And still another aspect includes calculating a potential risk of low fluid level by inputting the fluid level of the fluid system before execution of the fluid request command, the amount of time that fluid from the fluid system was being spent in response to execution of the fluid request command, and the plurality of external inputs that may affect the frequency for initiating the fluid request command into a remaining useful fluid prediction model. And yet another aspect includes providing a low fluid level alert to on-board and/or off-board systems when a risk of low fluid level is calculated by the remaining useful fluid prediction model.

A further aspect in accordance with the exemplary embodiment is provided wherein determining the fluid level includes using a fluid level sensor. And a further aspect is provided wherein determining the amount of time that fluid from the fluid system is being spent includes monitoring a fluid pump's run time after the fluid request command is made. Still another aspect is provided wherein determining a plurality of external inputs includes at least monitoring location inputs, time inputs and vehicle dynamics inputs. And another aspect wherein the location inputs include at least outside air temperature, weather data, global positioning system data (GPS) and trip routing data. And another aspect wherein the time inputs include at least time of day and date. And another aspect wherein vehicle dynamics inputs include at least vehicle acceleration, cargo, and vehicle type.

Still further aspects in accordance with the exemplary embodiment are provided wherein calculating the potential risk of low fluid level includes using at least one control disposed with the remaining useful fluid prediction model, and wherein providing the on-board low fluid level alert includes activating an alert in at least an on-board driver information center or infotainment system. And another aspect wherein providing the off-board low fluid level alert includes providing an alert to a service hub, a cellphone, a central office, or a fleet coordination center. And yet another aspect wherein the low fluid level alert is a time remaining until empty alert and/or distance remaining until empty alert. And still another aspect wherein calculating further comprises performing on-board and/or off-board data analysis to determine if the low fluid level alert should be activated.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional diagram for the method to predict remaining time and expected consumption before a fluid system reaches a low fluid level in accordance with aspects of an exemplary embodiment; and

FIG. 2 is an illustration of an algorithm for the method to predict remaining time and expected consumption before a fluid system reaches a low fluid level in accordance with aspects of the exemplary embodiment.

In the drawings, reference numbers may be reused to identify similar and/or identical elements.

### DETAILED DESCRIPTION

Current fluid systems on vehicles, e.g., windshield washer fluid system, AV sensor cleaning system, have no means for estimating how much fluid will be needed for future vehicle trips. A reliable fluid management system would be beneficial for a fluid system to provide the customer with information regarding the useful life of the system during use spikes due to repeated cleaning in seasonal weather, e.g., snow, slush, dust, etc., or due to clearing objects that have drastically reduced visibility through the vehicle's windshield or its object detection sensors. Thus, the foregoing disclosure seeks to provide an exemplary embodiment of a method for providing customers or vehicle systems, e.g., AV sensor cleaning subsystem, with a calculated time and/or distance remaining before a low fluid level is reached during a current or upcoming trip.

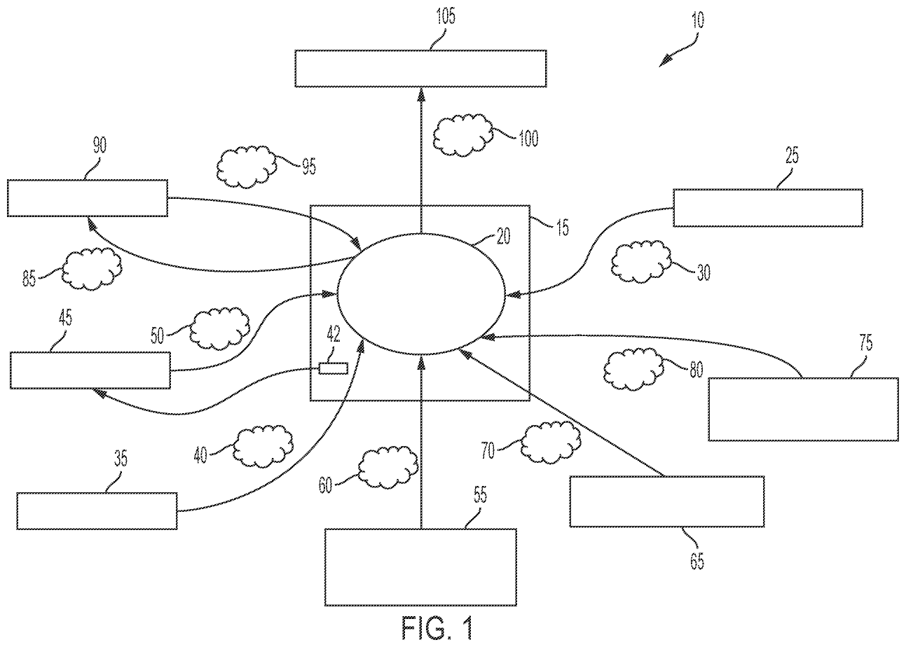

Referring to FIG. 1, a functional diagram 10 for the method to predict remaining time and/or remaining distance before a fluid system reaches a low fluid level in accordance with aspects of an exemplary embodiment is provided. A fluid system control module 15 is responsible for controlling various fluid systems, e.g., washer fluid, AV sensor cleaner, etc., within a vehicle. The fluid control module 15 includes a plurality of I/Os for receiving and sending requests and/or commands, respectively, to other on-board computers or subsystems to facilitate the operation of a washing or cleaning process of the vehicle windshield or object sensing subsystem. The fluid control module 15 may be a standalone unit or be integrated in an existing controller such as a body control module or other control module suitable for such purpose.

The fluid system control module 15 is disposed with a remaining useful fluid prediction model 20. The remaining useful fluid prediction model 20 is operative to estimate the expected consumption of fluid used before or during a trip and to calculate the potential risk of a low fluid level event occurring during a current or upcoming vehicle trip. The expected consumption would include the estimation would include considering the remaining distance since distance may be a factor of expected use, but expected use can be calculated without determining remaining distance based on external inputs, e.g., environmental inputs, time inputs, location inputs, and vehicle dynamic inputs. The remaining useful fluid prediction model 20 develops a profile of how and why a fluid system is used based on information received from various subsystems and sensors. Perception subsystems 25 such as, but not limited to, front and rear cameras, Lidar, radar subsystems are operative to detect dirt and/or debris on windshield or lens surfaces and to send a request to clean 30 the respective surface to the fluid system control module 15. Upon receiving the request to clean 30 the fluid system control module 15 determines the current fluid level 40 by reading the fluid level sensor 35. The fluid level sensor 35 may be a continuous level sensor operative to determine the exact amount of liquid in a containment at any point in time, or rather the fluid level sensor 35 may be of a virtual type this is capable of inferring a fluid level based on indirect evidence. After determining the fluid level, the fluid system control module 15 commands on a relay 42 to energize a fluid pump 45 causing fluid to be delivered from a fluid system reservoir (not shown) to the appropriate fluid system that initiated the request to clean 30. Once the fluid pump 45 is energized the fluid system control module 15 monitors the amount of time 50 that the relay 42 was on which when used in combination with other factors, e.g., amount of fluid pumped/sec*runtime, can be used to determine how much fluid was spent.

Environmental inputs 55 received from sensors or various off-board sources 55 are used to provide feedback 60 to the fluid system control module 15. The sensors and/or off-board sources 55 may include but, not limited to, an outside air temperature sensor, GPS, weather information, navigation and trip routing data. The environmental inputs 60 are useful in for determining when the vehicle is being or will be operated in conditions where a request to clean 30 would be initiated thus creating a need to activate the fluid pump 45.

Time inputs 65 such as the time of day and the date are provided as feedback 70 to the fluid system control module 15 as well. Knowing if the vehicle is being driven at night and/or during inclement seasonal weather can give cause to initiate a request to clean 30 due to potential low visibility in such conditions and the desire to have optimal performance from the perception systems 25.

Vehicle dynamic inputs 75 are received for various sensors and/or other on-board components to provide feedback 80 including, but not limited to, vehicle speed, driving mode, vehicle type, and vehicle load. The sensors may include, but not limited to, a vehicle speed sensor and a load sensor while the other on-board components may include, but not limited to, a transmission control module (TCM) and engine control module (ECM).

The environmental inputs 55, the time inputs 65, and the vehicle dynamic inputs 75 are utilized by the remaining useful fluid predictive model 20 to calculate the potential risk of a low fluid level event occurring during a current or upcoming vehicle trip. Alternatively, the fluid system control module 15 may deliver the inputs (55, 65, 75) in a data packet 85 to an off-board analysis site or server 90 to analyze the inputs to calculate the potential risk of a low fluid low event. If the off-board analysis site or server 90 determines that a low fluid level event is likely then warning information 95 is returned to the fluid system control module 15. The remaining useful fluid prediction model 20 receives the warning information 95, or it determines that a low fluid level event is likely to occur without the use of an off-board analysis site or server 90. Thereafter, the fluid system control module 15, via the remaining useful fluid prediction model 20, will cause a low fluid alert 100 to be sent to at least one on-board and/or off-board alert location 105 which may include, but not limited to, an on-board driver information center (DIC), an infotainment system, other vehicle system capable of relaying low fluid level alert information to the vehicle operator, a service center, a cellphone, a central office, e.g., Onstar®, or to fleet coordination center for data analysis. The low fluid alert 100 may be presented as, but not limited to, a time or distance remaining until a low fluid level condition occurs.

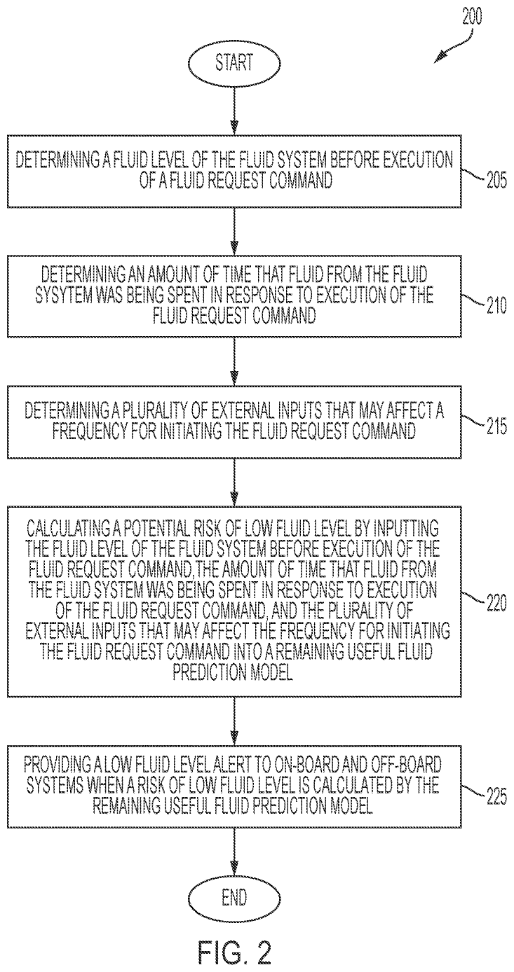

Referring now to FIG. 2, an illustration of an algorithm 200 for the method to predict remaining time and/or remaining distance before a fluid system reaches a low fluid level in accordance with aspects of the exemplary embodiment is provided. The method begins at block 205 with determining a fluid level of the fluid system before execution of a fluid request command. This is accomplished via the use of a fluid level sensor disposed in a fluid reservoir or containment and monitored by the fluid system control module.

Next, at block 210, the method continues with determining an amount of time that fluid from the fluid system was spent in response to execution of the fluid request command. The fluid system control module is operative to energize a relay to cause the fluid pump to begin pumping fluid in response to a fluid request command. When the fluid pump begins operation the fluid system control module starts a timer to track how long the pump is turned on and stores the time in memory until the next fluid request command.

At block 215 the method continues with determining a plurality of external inputs that may affect a frequency for initiating the fluid request command. The external inputs may include, but not limited to, location inputs, time and date inputs, and vehicle dynamics inputs. The external inputs may be acquired from on-board or off-board sources which may include vehicle sensors or via telematics technology, respectively.

At block 220 the method continues with calculating a potential risk of low fluid level by inputting the fluid level of the fluid system before execution of the fluid request command, the amount of time that fluid from the fluid system was being spent in response to execution of the fluid request command, and the plurality of external inputs that may affect the frequency for initiating the fluid request command into a remaining useful fluid prediction model. The remaining useful fluid prediction model develops a profile of how, when, and why an on-board fluid system is used. This information is then applied to predict if the current fluid level may not be sufficient to meet fluid demands for a current or future vehicle trip.

At block 225, the method ends with providing a low fluid level alert to on-board and off-board systems when a risk of low fluid level is calculated by the remaining useful fluid prediction model. The on-board and off-board systems may include, but not limited to, a driver information center, a service center, or to a fleet coordination center for off-board data analytics. The low fluid level alert may be presented as a time or distance remaining until a low fluid level condition occurs.

The disclosed method in accordance with an exemplary embodiment uses a fluid pump, a fluid level sensor, vehicle dynamics and environmental inputs, and statistical modeling to develop a profile of how and why a fluid system is used. The model collects inputs related to the vehicle dynamics, driver behavior, location and external environment to develop a profile of how fluid is used. The remaining useful fluid predictive model then uses the profile and current inputs during vehicle use to adaptively predict the remaining useful fluid with respect to the current state of the vehicle and/or coordinates for final destination of vehicle use. This profile can be used to dynamically estimate when a low fluid level condition will occur during a vehicle trip or upon placing a destination in a GPS, which can prevent experiencing vision blurriness for the driver or an advanced driver assistance system (ADAS)

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc.

What is claimed is:

1. A method to predict remaining time and expected consumption before a fluid system reaches a low fluid level comprising:
determining a fluid level of the fluid system before execution of a fluid request command;
determining an amount of time that fluid from the fluid system was spent in response to execution of the fluid request command;
determining a plurality of external inputs that may affect a frequency for initiating the fluid request command;
calculating a potential risk of low fluid level by inputting the fluid level of the fluid system before execution of the fluid request command, the amount of time that fluid from the fluid system was being spent in response to execution of the fluid request command, and the plurality of external inputs that may affect the frequency for initiating the fluid request command into a remaining useful fluid prediction model; and
providing a low fluid level alert to on-board and/or off-board systems when a risk of low fluid level is calculated by the remaining useful fluid prediction model.

2. The method of claim 1 wherein determining the fluid level includes using a fluid level sensor.

3. The method of claim 1 wherein determining the amount of time that fluid from the fluid system is being spent includes monitoring a fluid pump's run time after the fluid request command is made.

4. The method of claim 1 wherein determining a plurality of external inputs includes at least monitoring location inputs, time inputs and vehicle dynamics inputs.

5. The method of claim 4 wherein the location inputs include at least outside air temperature, weather data, GPS and trip routing data.

6. The method of claim 4 wherein the time inputs include at least time of day and date.

7. The method of claim 4 wherein vehicle dynamics inputs include at least vehicle acceleration, cargo, and vehicle type.

8. The method of claim 1 wherein calculating the potential risk of low fluid level includes using at least one control disposed with the remaining useful fluid prediction model.

9. The method of claim 1 wherein providing the on-board low fluid level alert includes activating an alert in at least an on-board driver information center or an infotainment system.

10. The method of claim 1 wherein providing the off-board low fluid level alert includes providing an alert to a service hub, a central office, a cellphone, or a fleet coordination center.

11. The method of claim 1 wherein the low fluid level alert is a time remaining until empty alert and/or distance remaining until empty alert.

12. The method of claim 1 wherein calculating further comprises performing on-board and/or off board data analysis to determine if the low fluid level alert should be activated.
